(19) United States
(12) Patent Application Publication
(10) Pub. No.: US 2009/0128001 A1
(43) Pub. Date: May 21, 2009

(54) ELECTRODE FOR COLD-CATHODE FLUORESCENT LAMP

(75) Inventors: Koji Nitta, Osaka (JP); Shinji Inazawa, Osaka (JP); Akihisa Hosoe, Osaka (JP); Kazuo Yamazaki, Osaka (JP); Hisashi Tokuda, Osaka (JP)

Correspondence Address: OSHA LIANG L.L.P., TWO HOUSTON CENTER, 909 FANNIN, SUITE 3500, HOUSTON, TX, 77010, US

(73) Assignees: SUMITOMO ELECTRIC INDUSTRIES, LTD., Osaka (JP); SUMIDEN FINE CONDUCTORS, CO., LTD., Osaka (JP)

(21) Appl. No.: 11/996,940

(22) PCT Filed: Mar. 15, 2007
(86) PCT No.: PCT/JP2007/055283

§ 371 Date: Jan. 25, 2008

(30) Foreign Application Priority Data
Aug. 4, 2006 (JP) 2006-213948
Nov. 29, 2006 (JP) 2006-322638

(51) Int. Cl. H01J 1/30

(52) U.S. Cl. 313/491

(57) ABSTRACT

A cold-cathode fluorescent lamp having high brightness with long life and an electrode for this lamp are offered. The electrode comprises a base and a covering layer that covers the surface of the base. The base is formed of one metal selected from nickel, a nickel alloy, iron, and an iron alloy. Consequently, a base having a shape, such as a cup, can be easily produced. The covering layer comprises (a) a surface layer made of tungsten or molybdenum and (b) a bonding layer that is made of zinc alloy and that is placed between the base and the surface layer. In comparison with nickel and iron, tungsten and molybdenum are resistant to sputtering, have a small work function, and have a high melting point. The presence of the bonding layer enables sufficient bonding between the surface layer and base. A cold-cathode fluorescent lamp provided with the foregoing electrode can suppress the reduction in brightness and the consumption of the electrode. Therefore, it has high brightness and long life.

### TECHNICAL FIELD

The present invention relates to an electrode to be used for a cold-cathode fluorescent lamp and a cold-cathode fluorescent lamp provided with the foregoing electrode. In particular, the present invention relates to an electrode suitable for a cold-cathode fluorescent lamp having high brightness and long life.

### BACKGROUND ART

Cold-cathode fluorescent lamps have been used as various light sources such as a light source for illuminating documents in a copying machine, an image scanner, or the like and a light source as a backlight for a liquid-crystal monitor of a personal computer or for a liquid-crystal display of a liquid-crystal television or the like. A cold-cathode fluorescent lamp is typically provided with a glass tube that has a layer of a fluorescent substance on its inner surface, that has sealed-in rare gas and mercury, and that has a pair of electrodes in it. A lead wire is welded to the end portion of each of the electrodes to apply voltage through it. The lead wire is typically classified into an inner lead wire that is fixed in the glass tube and an outer lead wire that is placed outside the tube. The fluorescent lamp emits light through the following process: (a) a high voltage is applied across the two electrodes, (b) electrons in the glass tube are forced to collide with the electrode, (c) the electrode emits electrons (to form electric discharge), (d) the interaction between the discharge and the mercury in the tube radiates ultraviolet light, and (e) the ultraviolet light stimulates the fluorescent substance to emit light. A representative example of the above-described electrode is made of nickel (see Patent literature 1).

Patent literature 1: the published Japanese patent application 2005-327485.

### DISCLOSURE OF THE INVENTION

### Problem to be Solved by the Invention

In recent years, the market has strongly required to get a cold-cathode fluorescent lamp having high brightness and long life. Consequently, an electrode that satisfies the foregoing requirement has been needed.

To achieve high brightness, it is conceivable to increase the current to be fed to the electrode. However, if the current is increased, the consumption of the electrode is sped up due to sputtering and the like, thereby shortening the life. In addition, in recent years, in view of the circumstances of the energy-saving effort, there has been a tendency of evading the increase in the current. Therefore, it is necessary to improve the performance of the electrode itself.

The present invention has been made in view of the above-described circumstances. A main object of the present invention is to offer an electrode suitable for a cold-cathode fluorescent lamp having long life and high brightness. Another object of the present invention is to offer a cold-cathode fluorescent lamp having high brightness and long life.

### Means to Solve the Problem

To realize a cold-cathode fluorescent lamp having high brightness and long life, the present inventors have studied the property needed for the electrode industriously by focusing attention particularly on the following points: (a) the electrode is to have excellent ion-sputtering resistance, (b) the electrode is to have a low working function, and (c) the electrode is to have a high melting point.

In a cold-cathode fluorescent lamp, a phenomenon known as “sputtering” occurs through the following process: mercury ions produced by the discharge between the electrodes collide with the electrodes to scatter the electrode sub-stance in the glass tube and deposit it on the inner surface of the glass tube. When the electrode easily allows the occurrence of the sputtering, the sputtering produces a deposited matter (a sputtering layer) composed of the electrode material. The deposited matter finally covers the fluorescent substance, decreasing the brightness of the fluorescent lamp. In addition, because the sputtering consumes the electrode, the life of the fluorescent lamp is shortened. Consequently, when the fluorescent lamp becomes resistant to the occurrence of the sputtering, the fluorescent lamp can have high brightness and long life.

The minimum energy needed to draw out an electron from the surface of a solid into a vacuum is defined as a work function. Therefore, it is difficult to draw out an electron from an electrode having a large work function. In other words, it is difficult to cause the electrode to discharge. When it is difficult to cause the electrode to discharge, the number of emitted electrons is small. Consequently, ultraviolet light radiates insufficiently, making it difficult to increase the brightness of the fluorescent lamp. As a result, an electrode having a large work function requires large current, thereby decreasing the energy efficiency. Moreover, the large current expedites the sputtering, shortening the life of the fluorescent lamp. In contrast, an electrode having a small work function causes the fluorescent lamp to have high brightness and long life. In addition, because an electrode having a small work function facilitates the increasing of the brightness, when the electrode is used at the same brightness as that of an electrode that is resistant to discharging, the life of the fluorescent lamp can be prolonged.

On the other hand, the energy when the electron in the glass tube collides with the electrode is as extremely high as 10⁷ eV or so. Consequently, an electrode having a low melting point (or a low liquidus temperature) will melt at the atomic level when collided by electrons. After the melting, it liquefies or vaporizes, rendering the discharging insufficient. As a result, the brightness of the fluorescent lamp is decreased. Furthermore, the consumption of the electrode due to the above-described liquefaction and vaporization shortens the life of the fluorescent lamp. Therefore, the use of an electrode having a high melting point can reduce the consumption of the electrode due to the collision of electrons, enabling the fluorescent lamp to have high brightness and long life.

As the material that satisfies the properties described in (a) to (c) above, there are tungsten and molybdenum. Engineers have been studying the tungsten and molybdenum as the material for forming the electrode for a cold-cathode fluorescent lamp. However, tungsten and molybdenum have poor plastic processibility in comparison with a metal such as nickel, a nickel alloy, iron, and an iron alloy. For example, when cup-shaped electrodes are mass-produced, it is desirable to use a material having excellent plastic processibility, such as the above-described metals including nickel. Consequently, in consideration of the properties described in (a) to (c) above and the producibility, an electrode of the present invention is structured by combining these metals.

More specifically, an electrode of the present invention for a cold-cathode fluorescent lamp comprises (a) a base composed of one metal selected from nickel, a nickel alloy, iron, and an iron alloy and (b) a covering layer that covers at least one part of the surface of the base. The covering layer is specified to have a layer made of tungsten or molybdenum at the surface side. In the covering layer, a bonding layer made of zinc or zinc alloy is placed between the base and the surface layer placed at the surface side.

As described above, in an electrode of the present invention, at least one part of the electrode surface is formed by using a metal that has excellent ion-sputtering resistance, a small work function, and a high melting point, such as tungsten or molybdenum. Having this structure, an electrode of the present invention not only reduces the sputtering itself but also reduces the consumption of the electrode due to the sputtering and due to the melting at the time of the collision of electrons. In addition, an electrode of the present invention facilitates the emission of electrons from the surface layer having a small work function, enabling sufficient discharging. Because an electrode of the present invention has the bonding layer, the surface layer made of tungsten or molybdenum can be bonded to the base, so that the above-described effect of the surface layer can be exerted sufficiently. Furthermore, because an electrode of the present invention has a base composed of a material, such as nickel, a nickel alloy, iron, or an iron alloy, which has excellent plastic processibility, the electrode is excellent in producibility. As a result, by using an electrode of the present invention, a cold-cathode fluorescent lamp having high brightness and long life can be produced with high efficiency. The present invention is explained below in further detail.

The material for forming the base of an electrode of the present invention is specified to be one metal selected from nickel, a nickel alloy, iron, and an iron alloy. In the present invention, the foregoing nickel is specified to be pure Ni composed of Ni and unavoidable impurities. Nickel is excellent in plastic processibility and cost efficiency. In consideration of the plastic processibility, it is desirable that the nickel alloy formed by adding an alloying element to pure Ni have the highest possible content of Ni. It is desirable that the content be at least 95 mass percent (the term “mass percent” is used to mean “weight percent” throughout this specification). The Ni alloy may contain at least one element selected from the group consisting of Ti, Hf, Zr, V, Fe, Nb, Mo, Mn, W, Sr, Ba, B, Th, Be, Si, Al, Y, and rare-earth elements (except Y) with a total amount of at least 0.001 mass percent and at most 5.0 mass percent, with the remainder being composed of Ni and impurities. Alternatively, the Ni alloy may contain at least one element selected from the group consisting of Be, Si, Al, Y, and rare-earth elements (except Y) (these elements are included in the foregoing group of elements) with a total amount of at least 0.001 mass percent and at most 3.0 mass percent, with the remainder being composed of Ni and impurities. In particular, it is desirable to use an Ni alloy containing Y, because the alloy can increase the sputtering resistance.

The nickel alloy containing the above-described alloying element has various advantages as shown below:
(a) it has a work function smaller than that of pure Ni, thereby facilitating the discharging,
(b) it is resistant to sputtering (a sputtering rate or etching rate is small),
(c) it is resistant to forming an amalgam, and
(d) it is resistant to forming an oxide film, so that the discharging is impervious to being impeded.
   Therefore, in the case of an electrode having a covering layer on the base made of the foregoing nickel alloy, even when the covering layer is consumed and consequently the base is exposed, the electrode can suppress the reduction in brightness and the consumption of the electrode. The work function and etching rate can be varied by changing the types of the alloying element in the Ni alloy and controlling the content of the alloying element.

As the material for forming the base of an electrode of the present invention, iron (Fe) or an iron alloy (an Fe alloy) may also be used. As described above, of the lead wires that supply electric power to the electrode, the inner lead wire is fixed in the glass tube. The inner lead wire is usually formed by using a material having a coefficient of thermal expansion close to that of the glass. As the material satisfying this requirement, an iron-nickel-cobalt alloy is used that is formed by adding cobalt (Co) and nickel (Ni) to iron. As the iron-nickel-cobalt alloy, there is an alloy known as Kovar, for example. In addition to the foregoing material, as the material for forming the inner lead wire, an iron-nickel alloy and an iron-nickel-chromium alloy may also be used. These iron alloys are excellent in plastic processibility and cutting processibility. Consequently, when the inner lead wire and the electrode are formed as a unitary body by using the foregoing iron alloy, the producibility can be improved because it is not necessary to produce the two members separately and to bond them by welding or another method. On the other hand, iron is superior to tungsten and molybdenum in plastic processibility. In addition, iron has a melting point close to that of the above-described iron alloy to be used as the material for forming the inner lead wire. Consequently, the base made of iron can be bonded to the inner lead wire by welding easily and reliably. Iron and an iron alloy are relatively low-cost and therefore excellent in cost efficiency, The above-described facts render iron and an iron alloy desirable material for forming the base. However, iron and an iron alloy themselves are poor in electron-emitting property and sputtering resistance. Therefore, it is considered that when an electrode is formed by using iron or an iron alloy, the electrode has difficulty in sufficiently having the property required for the electrode. On the other hand, a metal that forms the foregoing covering layer, such as tungsten or molybdenum, has an excellent electron-emitting property and sputtering resistance in comparison with iron and an iron alloy. Consequently, when the above-described covering layer is provided on the base made of iron or iron alloy, the electron-emitting property and sputtering resistance can be improved. Such an electrode is likely to contribute to the increase in the brightness and life of the fluorescent lamp.

The types of iron and iron alloy include (a) the so-called pure iron that contains at most 0.1 mass percent carbon (C) and at least 99.9 mass percent Fe with the remainder being composed of impurities and (b) steel. It is not desirable to use steel containing more than 0.1 mass percent carbon because it has high hardness and generates flaws and surface unevenness at the time of machining, thereby adversely affecting the surface properties. As an iron alloy other than steel, it is desirable to use an alloy that has a coefficient of thermal expansion close to that of the glass, as described above. The types of such an alloy include an Ni-containing alloy, namely, an iron-nickel alloy. The types also include a cobalt-added iron-nickel alloy, which is an iron-nickel-cobalt alloy, and a chromium-added iron-nickel alloy, which is an iron-nickel-chromium alloy. The specific compositions of these iron alloys are shown below.

(a) An iron-nickel alloy: the alloy contains 41 to 52 mass percent Ni with the remainder being composed of Fe and impurities.

This alloy may further contain at most 0.8 mass percent Mn and at most 0.3 mass percent Si.

(b) An iron-nickel-cobalt alloy: the alloy contains 28 to 30 mass percent Ni and 16 to 20 mass percent Co with the remainder being composed of Fe and impurities.

This alloy may further contain 0.1 to 0.5 mass percent Mn and 0.1 to 0.3 mass percent Si. In addition, as this alloy, commercially available Kovar may be used.

(c) An iron-nickel-chromium alloy: the alloy contains 41 to 46 mass percent Ni and 5 to 6 mass percent Cr with the remainder being composed of Fe and impurities.

This alloy may further contain at most 0.25 mass percent Mn.

As the shape of the base, various shapes can be used. Typical examples include the shape of a cup, which is a hollow tube having a bottom, and the shape of a solid column. The cup-shaped electrode is desirable because it can suppress the sputtering to a certain extent on account of the hollow-cathode effect. The columnar electrode can be formed by cutting, in a specified length, a wire-shaped material made of the material for forming the base. Therefore, its production is easy. The cup-shaped electrode can be formed, for a typical example, by pressing a plate-shaped material made of the above-described material for forming the base. When the main body of the electrode made of the above-described base-forming material (the body before the covering layer is formed) and the inner lead wire are formed as a unitary body, first, a wire-shaped material made of the base-forming material is produced. Then, a forging operation is performed at one end of the wire-shaped material. Thus, the main body of the cup-shaped electrode can be formed. The other end of the wire-shaped material may be processed by cutting as required to adjust the diameter of the inner lead wire. Alternatively, the entire wire-shaped material made of the above-described base-forming material may be processed by cutting to unitarily form the cup-shaped main body of the electrode and the wire-shaped inner lead wire. When a solid columnar main body of the electrode and a wire-shaped inner lead wire are unitarily formed, one end of the above-described wire-shaped material may be used as the main body of the electrode and the other end may be used as the inner lead wire. The other end of the wire-shaped material may be processed by cutting as required to adjust the diameter of the inner lead wire. An electrode of the present invention is intended to include a structure in which the main body of the electrode and the inner lead wire are unitarily formed.

An electrode of the present invention can be obtained by forming a covering layer on the base (the main body of the electrode) produced in the foregoing specified shape. The covering layer is composed of a surface layer provided at its surface side and a bonding layer provided at the base side. The surface layer is composed of tungsten (W) or molybdenum (Mo). In comparison with nickel and iron, W and Mo are resistant to sputtering, have a small work function, and have a high melting point. Consequently, by using an electrode of the present invention, a fluorescent lamp having high brightness and long life can be obtained. In addition, W and Mo not only have a smaller work function than that of nickel and iron but also have a smaller electric resistivity than that of them. Therefore, by using an electrode of the present invention, not only can the energy efficiency be improved but also energy saving can be realized. In the present invention, the surface layer is specified to be composed of W or Mo (including unavoidable impurities). Nevertheless, the surface layer is permitted to contain zinc (Zn), which constitutes the below-described bonding layer, in the range of at most 5 mass percent.

As described above, W and Mo have excellent properties. However, they have a high hardness. Consequently, they have difficulty in bonding to a base made of nickel, nickel alloy, iron, or iron alloy, which is softer than W and Mo, so that they tend to separate from the base easily. To solve this problem, in an electrode of the present invention, a layer that has an excellent bonding property to both the base and the surface layer is provided between the base and the surface layer to bond them to each other.

Patent literature 1 has disclosed the production of a cylindrical electrode through the following way. First, a nickel plate is coated with molybdenum by the thermal spraying method using a metallic powder of molybdenum. The coated plate is rolled. The rolled plate is subjected to a bending process to produce a semicircular segment of an electrode. Finally, a pair of electrode segments are combined to obtain the cylindrical electrode. However, the technique disclosed in Patent literature 1 gives no consideration to a structure for preventing the separation of the molybdenum layer from the plate. As described above, it is difficult to bond W or Mo to nickel and the like. Therefore, it is likely that the electrode disclosed in Patent literature 1 tends to allow the molybdenum layer to separate easily. In addition, in the technique disclosed in Patent literature 1, the plate on which a molybdenum layer is formed is subjected to a bending process. Consequently, it appears that the molybdenum layer tends to be separated or damaged easily during the bending operation. Furthermore, the layer formed through the thermal spraying method has a large number of minute pores between the metallic particles. Then, the vapor of the mercury enters the base through these pores, causing the surface of the base to be amalgamated. As a result, it is probable that the bonding property of the layer deteriorates easily. In contrast, as described below, when the covering layer is formed by the plating method, no pore is produced. Therefore, the fluorescent lamp is expected to have long life. In addition, in the case of the thermal spraying method, it is difficult to form a layer on the inner surface of the cup-shaped electrode.

The present inventors have found that as the material for the bonding layer, it is desirable to use zinc (Zn), because it easily forms an alloy with Ni or Fe, which is the main constituent of the base. Consequently, a layer made of zinc alloy is specified to be used as the bonding layer. The layer made of zinc alloy can be formed either (a) by using zinc to form an alloy with Ni or Fe of the base or (b) by using a zinc alloy.

When zinc is used to form the zinc-alloy layer, by alloying Zn with Ni or Fe derived from the base, the layer functions as the bonding layer. Consequently, when a zinc-alloy layer is placed in the vicinity of the base as the least necessary condition, the layer can be used as the bonding layer. Therefore, the covering layer may be composed of a surface layer and a bonding layer made of zinc alloy. Alternatively, the covering layer may have a structure in which a bonding layer made of zinc alloy, a zinc layer, and a surface layer are placed in this order from the base. As described above, the bonding layer may include a portion in which an alloy is formed with Ni or Fe of the base.

When zinc is used to form the zinc-alloy layer, the zinc-alloy layer may be formed either by forming a zinc alloy through the diffusion activity from the base or by converting the surface portion of the base to a zinc alloy. In order to convert the surface portion of the base to a zinc alloy, electrolysis may be performed, for example. In this case, electrodeposited Zn diffuses into Ni or Fe, which is the main constituent of the base, to form an zinc alloy. Thus, the entire bonding layer can be composed of zinc alloy (nickel-zinc alloy or iron-zinc alloy). Therefore, in the present invention, the types of the zinc alloy forming the bonding layer include, in addition to a zinc alloy into which an alloying element is intentionally added, a zinc alloy formed by the diffusion of zinc into the element constituting the base, which zinc alloy is a nickel-zinc alloy or an iron-zinc alloy.

When the bonding layer is formed by using a zinc alloy, it is desirable that the alloy contain at least 5 mass percent zinc. It is desirable that the alloying element be the element that constitutes the base, particularly Ni or Fe, because the alloy has an excellent bonding property.

Both the surface layer and the bonding layer can be formed by the electro-plating method or the chemical vapor deposition method (the CVD method). In particular, the electroplating method, even when the base has a complicated shape such as the shape of a cup, can form a uniform covering layer on its surface, particularly the inner surface of the cup. Therefore, it is desirable to use this method. Furthermore, the electroplating method has an excellent mass-productivity and cost efficiency.

These surface layer and bonding layer can be formed independently from each other. Alternatively, both layers may be formed continuously. When continuously formed, the surface layer and the bonding layer are easily bonded to each other, which is desirable.

As its thickness increases, the surface layer can increase its contribution to the increase in the brightness and life of the cold-cathode fluorescent lamp. Consequently, no upper limit is specified in the thickness of the surface layer. However, when the surface layer is formed by the plating method, it is considered that the production limit is 10 μm or so. On the other hand, if the surface layer is excessively thin, particularly less than 0.05 μm, the effect of increasing the brightness and life of the cold-cathode fluorescent lamp cannot be expected. Therefore, it is desirable that the surface layer have a thickness of 0.05 to 10 μm, more desirably 0.3 to 5 μm, in particular.

The bonding layer is required only to have a thickness to such an extent that it can sufficiently bond the surface layer to the base. If the bonding layer is excessively thin, the surface layer tends to separate from the base easily. If excessively thick, cracking occurs at the surface of the base due to the expansion of the volume. More specifically, the bonding layer is specified to have a thickness of 0.1 to 3 μm, desirably 0.3 to 1 μm.

When the base has the shape of a cup, it is desirable that the covering layer be formed so as to cover at least the entire inner surface of the cup, more specifically, the entire surface of both the inner circumferential surface of the tubular portion of the cup and the inner surface of the bottom portion. Of course, the covering layer may be formed so as to cover the entire surface of both the inner surface and the outer surface of the cup. When the covering layer is provided partially, it is recommended that the covering layer be formed by taking a measure to make sure that the portion not to be provided with the covering layer is not provided with it. For example, when the covering layer is formed through the plating method, the base may be partially masked or a sacrificial electrode may be used. When the covering layer is formed through the CVD method, a shielding plate may be used that controls the diffusion area of the gas that forms the covering layer. When the electrode is produced by unitarily forming the inner lead wire and the main body of the electrode, the surface of the inner lead wire is provided with the foregoing masking or the like to pre-vent the formation of the covering layer.

When the base is formed by using a nickel alloy, the covering layer may be formed after the surface of the base is coated with nickel. More specifically, the covering layer may have a structure in which a nickel layer, a bonding layer, and a surface layer are formed in this order from the base. By providing the nickel layer, the alloying of nickel with zinc, which is the main constituent of the bonding layer, can be facilitated, thereby increasing the bonding strength between the surface layer and the base. As with the surface layer and bonding layer, the nickel layer may be formed by the plating method or the chemical vapor deposition method (the CVD method).

An electrode of the present invention is used as the electrode for a cold-cathode fluorescent lamp. The cold-cathode fluorescent lamp is provided with a glass tube that has a layer of a fluorescent substance on its inner surface, that has sealed-in rare gas, such as argon or xenon, and mercury, and that has an electrode of the present invention in it.

### EFFECT OF THE INVENTION

An electrode of the present invention is structured such that the surface-side portion of the covering layer is formed by using a material that has excellent ion-sputtering resistance, a small work function, and a high melting point. Consequently, when the electrode is used as the electrode of a cold-cathode fluorescent lamp, the lamp can effectively suppress the reduction in the brightness and the consumption of the electrode. In particular, an electrode of the present invention provided with the bonding layer can bond the surface layer, which exerts the above-described effects, to the base. As a result, a cold-cathode fluorescent lamp of the present invention provided with an electrode of the present invention has high brightness and long life. Furthermore, because the electrode of the present invention forms the base using a material having excellent plastic processibility, the electrode is excellent in producibility.

### BEST MODE FOR CARRYING OUT THE INVENTION

Embodiments of the present invention are explained below.

Materials for forming bases having compositions shown in Table 1 were used to produce cup-shaped electrodes and circular-column-shaped electrodes, each having an outer diameter of 1.6 mm and a length of 3.0 mm. Cold-cathode fluorescent lamps incorporating the electrode were produced to evaluate their brightness and life.

The cup-shaped electrodes were produced by the procedure shown below. The ingot made of the material for forming the base having the composition shown in Table 1 was processed by hot rolling. The obtained rolled plate was subjected to a heat treatment and a subsequent surface cutting process. The surface-treated material underwent repeated cold-rolling operations and heat treatments. Then, the final heat treatment (the softening treatment) was performed on the material to produce a plate-shaped material having a thickness of 0.1 mm. The plate-shaped material was cut to a specified size. The obtained piece of plate was subjected to a cold-pressing process to produce a cup-shaped base. The as-produced base was used as a cup-shaped electrode having no covering layer. On the other hand, a cup-shaped electrode having a covering layer was provided on the produced base with a bonding layer and a surface layer each having a composition as shown in Table 1 through the electroplating method. The procedure of the plating is described below. The thickness of the covering layer was varied by adjusting the plating time.

The circular-column-shaped electrodes were produced by the procedure shown below. The ingot made of the material for forming the base having the composition shown in Table 1 was processed by hot rolling. The obtained rolled wire rod was subjected to a combination of a cold drawing process and a heat treatment. Then, the final heat treatment (the softening treatment) was performed on the wire rod to produce a wire-shaped material having a diameter of 1.6 mm. The wire-shaped material was cut to a specified length (3 mm) to produce a circular-column-shaped base. The as-produced base was used as a circular-column-shaped electrode having no covering layer. On the other hand, a circular-column-shaped electrode having a covering layer was provided on the produced base with a bonding layer and a surface layer each having a composition as shown in Table 1 through the electroplating method. The procedure of the electroplating is described below. The thickness of the covering layer was adjusted by the plating time.

### The Procedure of Plating

### (a) Securing of Electrical Continuity

One end portion of a nickel wire having a diameter of 0.5 mm is wound on the circumference of the base. When the other end portion is connected to a power source, a current can be fed to the base.

### (b) Degreasing

The base onto which the nickel wire is wound (hereinafter this base is referred to as the object base) is immersed in a 10 mass percent NaOH solution at 80° C. for five minutes to be degreased. Subsequently, the object base is thoroughly washed with water.

### (c) Electrolytic Degreasing

Next, the object base is immersed in a 10 mass percent NaOH solution, and the other end of the nickel wire is connected to the negative pole of the power source. A titanium plate coated with platinum is immersed in the foregoing NaOH solution and is connected to the positive pole of the power source. Under this condition, a current is fed at a current density of 100 mA/cm² for three minutes to perform the electrolytic degreasing. Subsequently, the object base is thoroughly washed with water.

### (d) Surface Activation by Using Acid

The object base is immersed in a solution (30° C.), which is prepared by using 200 g/L of Kokeisan B (an activator made by Kizai Corp.), for three minutes to activate the surface of the base. Subsequently, the object base is thoroughly washed with water.

(e) Ni Plating (this Step is Performed Only when the Base is Made of Nickel Alloy)

A plating solution is prepared that contains 200 g/L of nickel chloride hexahydrate and 100 mL/L of hydrochloric acid. The object base is Ni-plated at room temperature for 60 seconds using the prepared plating solution. This step forms a coating of Ni plating having a thickness of 0.5 μm on the surface of the base except the portion that is covered with the nickel wire. More specifically, for the columnar base, the coating is formed on the circumferential surface of the columnar portion and the surface of both ends. For the cup-shaped base, the coating is formed on the inner and outer circumferential surfaces of the tubular portion and the inner and outer surfaces of the bottom portion. After the plating, the object base is thoroughly washed with water.

The following steps (f) to (h) are performed in a glove box having an argon atmosphere in which the dew point is controlled at −70° C. or below.

### (f) Preparation of Molten-Salt Plating Bath

ZnCl₂ and NaCl, which are dried under reduced pressure at 150° C. for 24 hours or more, are weighed at a molar ratio of 60 to 40 and are mixed together. They are placed in an alumina crucible (the SSA-S grade made by Nikkato Co.) to be heated to a temperature of 350° C., so that they are melted. Next, in the case where the surface layer is made of tungsten (W), a salt that dissolves 0.05 mol/kg of WCl₆ and 0.05 mol/kg of ZnO is further added into the foregoing alumina crucible. The content in the crucible is left standing for one hour or so while being stirred as required. Thus, the plating bath is prepared. On the other hand, in the case where the surface layer is made of molybdenum (Mo), a salt that dissolves 0.05 mol/kg of MoCl₃ and 0.05 mol/kg of ZnO is further added into the foregoing alumina crucible. The content in the crucible is left standing for one hour or so while being stirred as required. Thus, the plating bath is prepared.

### (g) Formation of Bonding Layer

The electrolysis is performed through the method shown in the step (c) by using the plating bath at 350° C. prepared in the step (f) above. The object base that is subjected to the pretreatment to the step (e) is used as the working electrode. For the covering layer made of tungsten (W), tungsten is used for the counter electrode. For the covering layer made of molybdenum (Mo), molybdenum is used for the counter electrode. Zinc is used for the reference electrode. Under the above-described condition, the electrolysis is performed for 30 minutes with the potential of the working electrode being set at 20 mV vs Zn²⁺/Zn. At the surface portion of the base except the portion covered with the nickel wire, this step performs the alloying of the portion, from the surface to the position 0.3 μm away depthwise from the surface, with Zn. In other words, the Zn is alloyed with either (a) the Ni, Fe, or Fe alloy that constitutes the base or (b) the Ni of the coating formed by the plating. The alloyed portion is used as the bonding layer having a thickness of 0.3 μm. For a bonding layer having a thickness of 0.05 μm, the electrolysis is performed for 20 minutes to form the bonding layer.

### (h) Formation of Surface Layer

Tungsten

Subsequent to the formation of the bonding layer in the step (g), electrolysis is performed for two hours with the potential of the working electrode being set at 60 mV vs Zn²⁺/Zn. At the surface portion of the base except the portion covered with the nickel wire, this electrolysis forms a surface layer made of tungsten having a thickness of 0.5 μm. More specifically, for the columnar base, the surface layer is formed on the circumferential surface of the columnar portion and the surface of both ends. For the cup-shaped base, the surface layer is formed on the inner and outer circumferential surfaces of the tubular portion and the inner and outer surfaces of the bottom portion. In the case of a tungsten layer having a thickness of 0.05 μm, the electrolysis is performed for 12 minutes to form the surface layer. In the case of a tungsten layer having a thickness of 2 μm, the electrolysis is performed for eight hours to form the surface layer.

Molybdenum

Subsequent to the formation of the bonding layer in the step (g), electrolysis is performed for one hour with the potential of the working electrode being set at 60 mV vs Zn²⁺/Zn. This electrolysis forms a surface layer made of molybdenum having a thickness of 0.5 μm at the same portion as in the case of the tungsten layer (except the portion covered with the nickel wire on the surface of the base). In the case of a molybdenum layer having a thickness of 0.05 μm, the electrolysis is performed for six minutes to form the surface layer. In the case of a molybdenum layer having a thickness of 5 μm, the electrolysis is performed for 10 hours to form the surface layer.

### (i) Water Washing and Drying

After the object base is taken out of the glove box, the nickel wire is removed from the base provided with the covering layer. After the base is thoroughly washed with water, it is dried in a thermostatic oven at 50° C. for 15 minutes. Thus, an electrode provided with the base and covering layer is obtained. Through the above-described procedure, electrodes having various structures were produced. Table 1 shows the produced electrodes.

After the covering layer was formed, the bonding condition of the surface layer was examined. The examination revealed that in every electrode, there was no separation of the bonding layer from the base, showing a sufficient bonding. In addition, after the covering layer was formed, the composition between the surface layer and the base was also examined. According to the examination, an Ni—Zn alloy, an Fe—Zn alloy, an Fe—Ni—Zn alloy, and an Fe-Ni-Co-Zn alloy were recognized. This result confirmed that there exists a bonding layer composed of zinc alloy.

TABLE 1
Structure of electrode

| | Covering layer | | | | | |
|---|---|---|---|---|---|---|
| | Surface layer | | Bonding layer | | | |
| Electrode | | Thickness | | Thickness | Base | |
| No. | Element | (μm) | Element | (μm) | Element | Shape |
| 1 | — | | | | Ni | Cup |
| 2 | W | 0.05 | Ni—Zn alloy | 0.3 | Ni | |
| 3 | W | 0.5 | Ni—Zn alloy | 0.3 | Ni | |
| 4 | W | 2 | Ni—Zn alloy | 0.3 | Ni | |
| 5 | W | 0.5 | Ni—Zn alloy | 0.05 | Ni | |
| 6 | W | 0.5 | Ni—Zn alloy | 0.3 | Ni— | |
| | | | | | 0.35 mass % Y | |
| 7 | — | | | | Ni | Circular |
| 8 | W | 0.5 | Ni—Zn alloy | 0.3 | Ni | Column |
| 9 | Mo | 0.05 | Ni—Zn alloy | 0.3 | Ni | Cup |
| 10 | Mo | 0.5 | Ni—Zn alloy | 0.3 | Ni | |
| 11 | Mo | 5 | Ni—Zn alloy | 0.3 | Ni | |
| 12 | W | 2 | Fe—Zn alloy | 0.3 | Fe— | |
| | | | | | 0.025 mass % C | |
| 13 | W | 2 | Fe—Ni—Zn alloy | 0.3 | Fe— | |
| | | | | | 42 mass % Ni | |
| 14 | W | 2 | Fe—Ni—Co—Zn alloy | 0.3 | Fe— | |
| | | | | | 30 mass % Ni— | |
| | | | | | 16 mass % Co | |

A cold-cathode fluorescent lamp was produced by the procedure shown below. An inner lead wire made of Kovar was welded with an outer lead wire made of copper-coated Ni-alloy wire. The inner lead wire was bonded by welding to the bottom face or end face of an electrode produced as described above. An electrode (base) made of nickel, nickel alloy, iron, or iron alloy and an inner lead wire made of Kovar have a melting point comparable or relatively close to each other. Consequently, they can be easily bonded to each other by welding. A glass bead was attached by fusion to the inner lead wire so as to enclose the entire outer circumference of it. This operation produced an electrode member in which the lead wires, electrode, and glass bead were consolidated into one unit. Two of the above-described electrode members were prepared. The base may be provided with the covering layer under the condition that both lead wires and the glass bead are attached to the base.

When an iron-nickel alloy or an iron-nickel-cobalt alloy is used as the material for forming the base, the base and inner lead wire may be formed unitarily. The procedure for producing the unitary body is shown below. First, a wire-shaped material is produced as in the case where the above-described circular-column-shaped electrode is produced. The wire-shaped material is cut to a specified length (4 mm). One end portion (the portion from the end face to a position longitudinally 1 mm away from the end face) of the obtained short material is subjected to a cold-forging process to produce a cup-shaped electrode. The other end portion undergoes a cutting process as required to produce a wire-shaped inner lead wire. An outer lead wire is bonded to the end of the inner lead wire.

On the other hand, a glass tube was prepared that had a fluorescent-substance layer (in this evaluation test, a halophosphate fluorescent-substance layer) on its inner surface and that had an open end at both sides. One electrode member was inserted into one end of the open-end tube. The glass bead and the end portion of the tube were fusion-bonded to each other, so that the end of the tube was sealed and the electrode member was fixed in the tube. Next, the glass tube was vacuum evacuated from the other end, which was still open, to introduce rare gas (in this evaluation test, Ar gas) and mercury. The other electrode member was fixed as with the foregoing electrode member and the glass tube was sealed. Through this procedure, in the case of the cup-shaped electrode, a cold-cathode fluorescent lamp (a sample) was obtained in which a pair of the opening portions of the electrodes were placed so as to face each other. In the case of the circular-column-shaped electrode, a cold-cathode fluorescent lamp (a sample) was obtained in which a pair of the end faces of the electrodes were placed so as to face each other.

The brightness and life of the produced individual samples are evaluated in the following way. The center brightness (43,000 cd/m²) and life of Sample No. 1 provided with Electrode No. 1 (a cup-shaped electrode made of Ni) are defined as 100 to use as the reference. The brightness and life of the individual samples provided with other electrodes are expressed in relation to the reference for the evaluation. The evaluation results are shown in Table 2. The life is defined as the period when the center brightness has decreased to 50 percent.

TABLE 2

| Sample No. | Brightness | Life |
|---|---|---|
| 1 | 100 | 100 |
| 2 | 270 | 110 |
| 3 | 280 | 120 |
| 4 | 290 | 150 |
| 5 | 280 | 120 |
| 6 | 290 | 390 |
| 7 | 80 | 40 |
| 8 | 230 | 55 |
| 9 | 220 | 105 |
| 10 | 230 | 110 |
| 11 | 240 | 160 |
| 12 | 285 | 130 |
| 13 | 290 | 140 |
| 14 | 285 | 140 |

As shown in Table 2, the sample provided with an electrode having a covering layer has a higher brightness and a longer life than those of the sample provided with an electrode having no covering layer. In particular, as the thickness of the surface layer of the electrode of a sample increases, the sample increases its brightness and life. According to these results, it is likely that the electrode provided with a covering layer contribute to the realization of a cold-cathode fluorescent lamp having high brightness and long life.

In addition, the sample provided with a cup-shaped electrode has a higher brightness and a longer life than those of the sample provided with a circular-column-shaped electrode. Furthermore, the sample provided with an electrode having a surface layer made of tungsten has a higher brightness and a longer life than those of the sample provided with an electrode having a surface layer made of molybdenum. The sample provided with an electrode having a base made of Ni alloy has a higher brightness and a longer life than those of the sample provided with an electrode having a base made of Ni. The reason why the sample provided with an electrode having the base made of Ni alloy has enhanced brightness and increased life can be considered as follows. Because the base made of Ni alloy not only allows the base itself to discharge easily but also has excellent sputtering resistance, even after the covering layer is consumed, the reduction in brightness and the consumption of the electrode can be suppressed. Moreover, the sample provided with an electrode having a base formed of Fe (containing 0.025 mass percent C) or Fe alloy has high brightness and long life. This is attributable to the fact that the covering layer not only has an excellent electron-emitting property, because it is made of metal having a small work function, but also has excellent sputtering resistance.

The above-described embodiments can be modified as required without deviating from the main point of the present invention and are not limited to the above-described structure. For example, the use of the glass bead may be eliminated.

The present invention is explained above in detail and by referring to the specific embodiments. It should be obvious to the person skilled in the art that the present invention can be altered or modified in various ways without deviating from the spirit and scope of the present invention. The present application is based on the Japanese patent application (Tokugan 2006-213948) filed on Aug. 4, 2006 and the Japanese patent application (Tokugan 2006-322638) filed on Nov. 29, 2006, and the description of these applications is incorporated herein as reference.

### INDUSTRIAL APPLICABILITY

An electrode of the present invention can be suitably used as the electrode for a cold-cathode fluorescent lamp. A cold-cathode fluorescent lamp of the present invention can be suitably used as the light source of various electric devices, such as a light source as a backlight for a liquid-crystal display, a light source as a frontlight for a small display, a light source for illuminating documents in a copying machine, a scanner, or the like, and a light source for an eraser of a copying machine.

1. An electrode for a cold-cathode fluorescent lamp, the electrode comprising:
(a) a base made of one metal selected from nickel, a nickel alloy, iron, and an iron alloy; and
(b) a covering layer that covers at least one part of the surface of the base;
the covering layer comprising:
(c) a surface layer made of tungsten or molybdenum; and
(d) a bonding layer that is made of zinc alloy and that is placed between the base and the surface layer.

2. An electrode for a cold-cathode fluorescent lamp as defined by claim 1, wherein:
(a) the base has the shape of a cup; and
(b) the covering layer is provided on the entire inner surface of the cup-shaped base.

3. A cold-cathode fluorescent lamp, having an electrode, the electrode comprising:
(a) a base made of one metal selected from nickel, a nickel alloy, iron, and an iron alloy; and
(b) a covering layer that covers at least one part of the surface of the base;
the covering layer comprising:
(c) a surface layer made of tungsten or molybdenum; and
(d) a bonding layer that is made of zinc alloy and that is placed between the base and the surface layer.

4. A cold-cathode fluorescent lamp, having an electrode as defined by claim 3, wherein:
(a) the base has the shape of a cup; and
(b) the covering layer is provided on the entire inner surface of the cup-shaped base.
